(19) United States
(12) Patent Application Publication
(10) Pub. No.: US 2026/0095597 A1
(43) Pub. Date: Apr. 2, 2026

(54) BASE MESH VERTEX MOTION CODING

(71) Applicant: Samsung Electronics Co., Ltd., Suwon-si (KR)

(72) Inventors: Rajan Laxman Joshi, San Diego, CA (US); Madhukar Budagavi, Plano, TX (US)

(21) Appl. No.: 19/339,266

(22) Filed: Sep. 24, 2025

Related U.S. Application Data
(60) Provisional application No. 63/701,184, filed on Sep. 30, 2024.
(60) Provisional application No. 63/701,873, filed on Oct. 1, 2024.
(60) Provisional application No. 63/712,301, filed on Oct. 25, 2024.
(60) Provisional application No. 63/723,467, filed on Nov. 21, 2024.

(51) Int. Cl. H04N 19/70; G06T 9/00

(52) U.S. Cl. CPC H04N 19/70; G06T 9/001

(57) ABSTRACT

An apparatus includes a communication interface configured to receive a compressed bitstream comprising a base mesh sub-bitstream and a processor operably coupled to the communication interface. The processor is configured to determine a value of a motion vector derivation disable flag. The processor is also configured to receive two syntax elements related to duplicate vertices, wherein values of the two syntax elements are based on the value of the motion vector derivation disable flag, and wherein the two syntax elements include a first syntax element for a last 1-bit position and a second syntax element for a trailing 0-bit. The processor is also configured to provide one or more bitstream conformance conditions based on the two syntax elements. The processor is also configured to confirm, based on the one or more bitstream conformance conditions, a correct number of motion vectors being signaled in a bitstream.

### CROSS-REFERENCE TO RELATED APPLICATION AND PRIORITY CLAIM

This application claims priority under 35 U.S.C. § 119 (e) to U.S. Provisional Patent Application No. 63/701,184 filed on Sep. 30, 2024, U.S. Provisional Patent Application No. 63/701,873 filed on Oct. 1, 2024, U.S. Provisional Patent Application No. 63/712,301 filed on Oct. 25, 2024, and U.S. Provisional Patent Application No. 63/723,467 filed on Nov. 21, 2024, which are hereby incorporated by reference in their entirety.

### TECHNICAL FIELD

This disclosure relates generally to multimedia devices and processes. More specifically, this disclosure relates to base mesh and vertex motion coding.

### BACKGROUND

Three hundred sixty degree (360°) video and three dimensional (3D) volumetric video are emerging as new ways of experiencing immersive content due to the ready availability of powerful handheld devices such as smartphones. While 360° video enables an immersive “real life,” “being-there,” experience for consumers by capturing the 360° outside-in view of the world, 3D volumetric video can provide a complete six degrees of freedom (DoF) experience of being immersed and moving within the content. Users can interactively change their viewpoint and dynamically view any part of the captured scene or object they desire. Display and navigation sensors can track head movement of a user in real-time to determine the region of the 360° video or volumetric content that the user wants to view or interact with. Multimedia data that is 3D in nature, such as point clouds or 3D polygonal meshes, can be used in the immersive environment. This data can be stored in a video format and encoded and compressed for transmission as a bitstream to other devices.

### SUMMARY

This disclosure provides for base mesh and vertex motion coding.

In one embodiment, an apparatus includes a communication interface configured to receive a compressed bitstream comprising a base mesh sub-bitstream and a processor operably coupled to the communication interface. The processor is configured to determine a value of a motion vector derivation disable flag. The processor is also configured to receive two syntax elements related to duplicate vertices, wherein values of the two syntax elements are based on the value of the motion vector derivation disable flag, and wherein the two syntax elements including a first syntax element for a last 1-bit position and a second syntax element for a trailing 0-bit. The processor is also configured to provide one or more bitstream conformance conditions based on the two syntax elements. The processor is also configured to confirm, based on the one or more bitstream conformance conditions, a correct number of motion vectors being signaled in a bitstream.

In another embodiment, a method includes receiving a compressed bitstream comprising a base mesh sub-bitstream. The method also includes determining a value of a motion vector derivation disable flag. The method also includes receiving two syntax elements related to duplicate vertices, wherein values of the two syntax elements are based on the value of the motion vector derivation disable flag, and wherein the two syntax elements include a first syntax element for a last 1-bit position and a second syntax element for a trailing 0-bit. The method also includes providing one or more bitstream conformance conditions based on the two syntax elements. The method also includes confirming, based on the one or more bitstream conformance conditions, a correct number of motion vectors being signaled in a bitstream.

In yet another embodiment, an apparatus includes a communication interface and a processor operably coupled to the communication interface. The processor is configured to determine a value of a motion vector derivation disable flag and include the value of the motion vector derivation disable flag in signaling information. The processor is also configured to determine two syntax elements related to duplicate vertices and include the two syntax elements in the signaling information, wherein the two syntax elements include a first syntax element for a last 1-bit position and a second syntax element for a trailing 0-bit, and wherein one or more bitstream conformance conditions are related to the two syntax elements. The processor is also configured to create a compressed bitstream including the signaling information.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with this disclosure;

FIGS. 2 and 3 illustrate example electronic devices in accordance with this disclosure;

FIG. 4 illustrates an example mesh frame encoding process in accordance with this disclosure;

FIG. 5 illustrates an example mesh frame decoding process in accordance with this disclosure;

FIG. 6 illustrates an example encoding method in accordance with this disclosure;

FIG. 7 illustrates an example decoding method in accordance with this disclosure; and

FIG. 8 illustrates an example method of setting conformance conditions in accordance with this disclosure.

### DETAILED DESCRIPTION

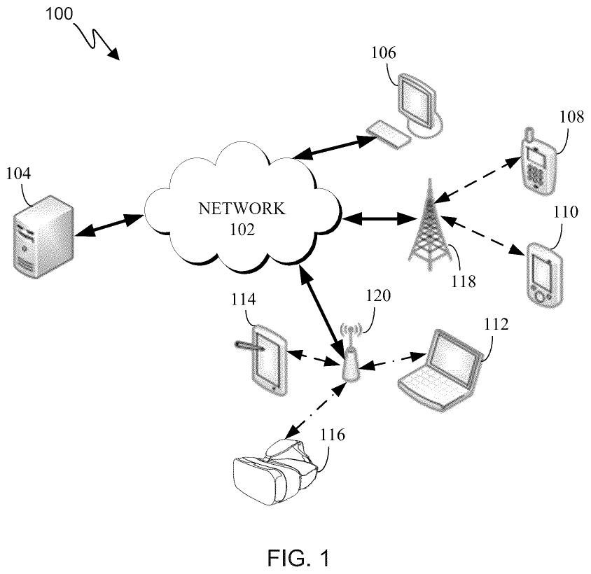

FIGS. 1 through 8, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

As noted above, three hundred sixty degree (360°) video and three dimensional (3D) volumetric video are emerging as new ways of experiencing immersive content due to the ready availability of powerful handheld devices such as smartphones. While 360° video enables an immersive “real life,” “being-there,” experience for consumers by capturing the 360° outside-in view of the world, 3D volumetric video can provide a complete six degrees of freedom (DoF) experience of being immersed and moving within the content. Users can interactively change their viewpoint and dynamically view any part of the captured scene or object they desire. Display and navigation sensors can track head movement of a user in real-time to determine the region of the 360° video or volumetric content that the user wants to view or interact with. Multimedia data that is 3D in nature, such as point clouds or 3D polygonal meshes, can be used in the immersive environment. This data can be stored in a video format and encoded and compressed for transmission as a bitstream to other devices.

A point cloud is a set of 3D points along with attributes such as color, normal directions, reflectivity, point-size, etc. that represent an object's surface or volume. Point clouds are common in a variety of applications such as gaming, 3D maps, visualizations, medical applications, augmented reality, virtual reality, autonomous driving, multi-view replay, and six degrees of freedom (DoF) immersive media, to name a few. Point clouds, if uncompressed, generally require a large amount of bandwidth for transmission. Due to the large bitrate requirement, point clouds are often compressed prior to transmission. Compressing a 3D object such as a point cloud, often requires specialized hardware. To avoid specialized hardware to compress a 3D point cloud, a 3D point cloud can be transformed into traditional two-dimensional (2D) frames and that can be compressed and later reconstructed and viewable to a user.

Polygonal 3D meshes, especially triangular meshes, are another popular format for representing 3D objects. Meshes typically include a set of vertices, edges and faces that are used for representing the surface of 3D objects. Triangular meshes are simple polygonal meshes in which the faces are simple triangles covering the surface of the 3D object. Typically, there may be one or more attributes associated with the mesh. In one scenario, one or more attributes may be associated with each vertex in the mesh. For example, a texture attribute (RGB) may be associated with each vertex. In another scenario, each vertex may be associated with a pair of coordinates, (u, v). The (u, v) coordinates may point to a position in a texture map associated with the mesh. For example, the (u, v) coordinates may refer to row and column indices in the texture map, respectively. A mesh can be thought of as a point cloud with additional connectivity information.

The point cloud or meshes may be dynamic, i.e., they may vary with time. In these cases, the point cloud or mesh at a particular time instant may be referred to as a point cloud frame or a mesh frame, respectively. Since point clouds and meshes contain a large amount of data, they require compression for efficient storage and transmission. This is particularly true for dynamic point clouds and meshes, which may contain 60 frames or higher per second.

As part of an encoding process, a base mesh can be coded using an existing mesh codec, and a reconstructed base mesh can be constructed from the coded original base mesh. The reconstructed base mesh can then be subdivided into one or more subdivided meshes and a displacement field is created for each subdivided mesh.

A standard for video-based dynamic mesh coding is being developed. As a part of the standard, a potentially simplified (lower resolution) base mesh is created and coded as a sub-bitstream. For base mesh coding, some frames are coded in inter mode. In this mode motion vectors for vertices are transmitted. The motion vectors are added to the corresponding vertex positions in a reference mesh frame to derive the position of the vertices in the current frame. When a vertex in the reference mesh frame is a duplicate of another vertex, a flag is signalled to indicate whether a motion vector needs to be signalled for that vertex. Two new syntax elements related to duplicate vertices are: bmidu_mv_signalled_flag_last1pos and bmidu_mv_signalled_flag_last1pos. These may be inferred when the value of the bmptc_motion_vector_derivation_disable_flag is 1. This disclosure also introduces bitstream conformance constraints to ensure that enough motion vectors are signaled in the bitstream.

FIG. 1 illustrates an example communication system 100 in accordance with this disclosure. The embodiment of the communication system 100 shown in FIG. 1 is for illustration only. Other embodiments of the communication system 100 can be used without departing from the scope of this disclosure.

As shown in FIG. 1, the communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a TV, an interactive display, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. As described in more detail below, the server 104 can transmit a compressed bitstream, representing a point cloud or mesh, to one or more display devices, such as a client device 106-116. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications. The HMD 116 can display 360° scenes including one or more dynamic or static 3D point clouds. In certain embodiments, any of the client devices 106-116 can include an encoder, decoder, or both. For example, the mobile device 108 can record a 3D volumetric video and then encode the video enabling the video to be transmitted to one of the client devices 106-116. In another example, the laptop computer 112 can be used to generate a 3D point cloud or mesh, which is then encoded and transmitted to one of the client devices 106-116.

In this example, some client devices 108-116 communicate indirectly with the network 102. For example, the mobile device 108 and PDA 110 communicate via one or more base stations 118, such as cellular base stations or eNodeBs (eNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s). In certain embodiments, the server 104 or any client device 106-116 can be used to compress a point cloud or mesh, generate a bitstream that represents the point cloud or mesh, and transmit the bitstream to another client device such as any client device 106-116.

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

In certain embodiments, any of the client devices 106-116 or the server 104 can create a 3D point cloud or mesh, compress a 3D point cloud or mesh, transmit a 3D point cloud or mesh, receive a 3D point cloud or mesh, decode a 3D point cloud or mesh, render a 3D point cloud or mesh, or a combination thereof. For example, the server 104 can compress a 3D point cloud or mesh to generate a bitstream and then transmit the bitstream to one or more of the client devices 106-116. As another example, one of the client devices 106-116 can compress a 3D point cloud or mesh to generate a bitstream and then transmit the bitstream to another one of the client devices 106-116 or to the server 104. In accordance with this disclosure, the server 104 and/or the client devices 106-116 can use a number of vertices of the original base mesh and/or distortion information for each reconstruction iteration to simplify submeshes. Additionally or alternatively, in accordance with this disclosure, the server 104 and/or the client devices 106-116 can use a copy of a decimated mesh for reconstructing one or more submeshes. In some embodiments, the server 104 and/or the client devices 106-116 can construct and transmit signaling information instructing another device to use a number of vertices of the original base mesh and/or distortion information for each reconstruction iteration to simplify submeshes and/or create and use a copy of a decimated mesh for reconstructing one or more submeshes.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

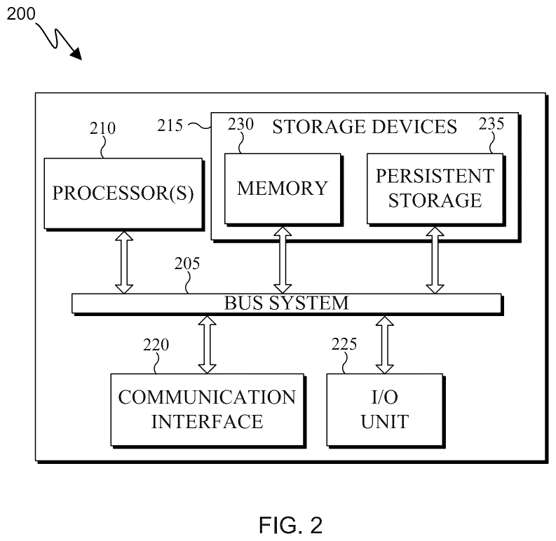

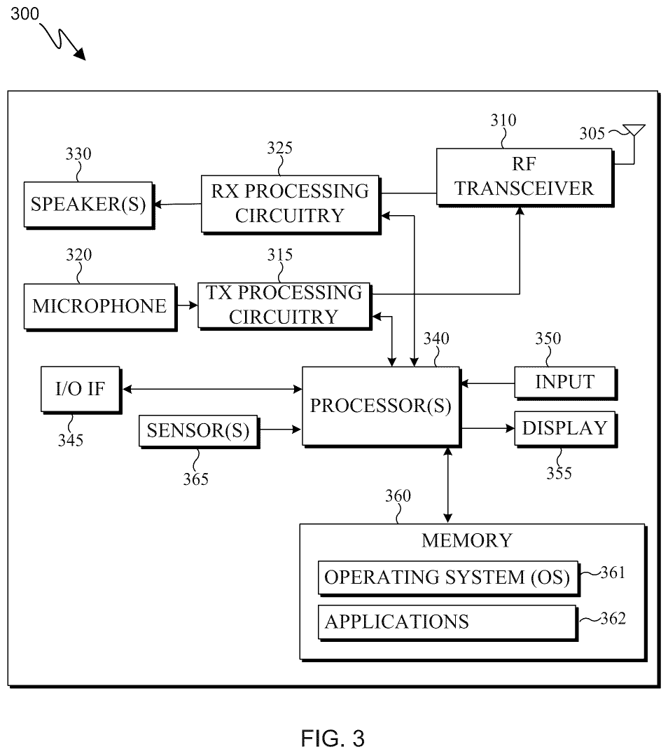

FIGS. 2 and 3 illustrate example electronic devices in accordance with this disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 can represent one or more local servers, one or more compression servers, or one or more encoding servers, such as an encoder. In certain embodiments, the encoder can perform decoding. As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

In certain embodiments, the processor 210 can encode a 3D point cloud or mesh stored within the storage devices 215. In certain embodiments, encoding a 3D point cloud also decodes the 3D point cloud or mesh to ensure that when the point cloud or mesh is reconstructed, the reconstructed 3D point cloud or mesh matches the 3D point cloud or mesh prior to the encoding. In certain embodiments, the processor 210 can use a number of vertices of the original base mesh and/or distortion information for each reconstruction iteration to simplify submeshes. Additionally or alternatively, the processor 210 can create and use a copy of a decimated mesh for reconstructing one or more submeshes as described in this disclosure. In some embodiments, the processor 210 can construct and transmit signaling information instructing another device to use a number of vertices of the original base mesh and/or distortion information for each reconstruction iteration to simplify submeshes and/or create and use a copy of a decimated mesh for reconstructing one or more submeshes.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). For example, the instructions stored in the memory 230 can include instructions for decomposing a point cloud into patches, instructions for packing the patches on 2D frames, instructions for compressing the 2D frames, as well as instructions for encoding 2D frames in a certain order in order to generate a bitstream. The instructions stored in the memory 230 can also include instructions for rendering the point cloud on an omnidirectional 360° scene, as viewed through a VR headset, such as HMD 116 of FIG. 1. The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

In certain embodiments, the processor 340 can use a number of vertices of the original base mesh and/or distortion information for each reconstruction iteration to simplify submeshes. Additionally or alternatively, the processor 340 can create and use a copy of a decimated mesh for reconstructing one or more submeshes as described in this disclosure. In some embodiments, the processor 340 can construct and transmit signaling information instructing another device to use a number of vertices of the original base mesh and/or distortion information for each reconstruction iteration to simplify submeshes and/or create and use a copy of a decimated mesh for reconstructing one or more submeshes.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within an HMD. The display 355 can be a singular display screen or multiple display screens capable of creating a stereoscopic display. In certain embodiments, the display 355 is a heads-up display (HUD). The display 355 can display 3D objects, such as a 3D point cloud or mesh.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, meshes, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein.

As discussed in greater detail below, one or more of these sensor(s) 365 may be used to control a user interface (UI), detect UI inputs, determine the orientation and facing the direction of the user for three-dimensional content display identification, and the like. Any of these sensor(s) 365 may be located within the electronic device 300, within a secondary device operably connected to the electronic device 300, within a headset configured to hold the electronic device 300, or in a singular device where the electronic device 300 includes a headset.

The electronic device 300 can create media content such as generate a virtual object or capture (or record) content through a camera. The electronic device 300 can encode the media content to generate a bitstream, such that the bitstream can be transmitted directly to another electronic device or indirectly such as through the network 102 of FIG. 1. The electronic device 300 can receive a bitstream directly from another electronic device or indirectly such as through the network 102 of FIG. 1.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

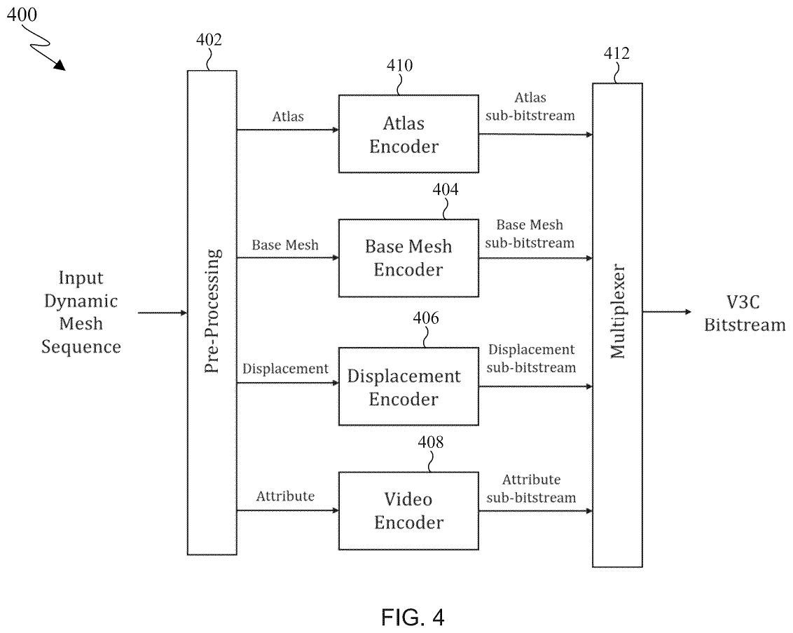

FIG. 4 illustrates an example encoding process 400 in accordance with this disclosure. The encoding process 400 illustrated in FIG. 4 is for illustration only. FIG. 4 does not limit the scope of this disclosure to any particular implementation of an encoding process. For ease of explanation, the process 400 of FIG. 4 may be described as being performed using the electronic device 300 of FIG. 3. However, the process 400 may be used with any other suitable system and any other suitable electronic device.

As shown in FIG. 4, the encoding process 400 performs pre-processing 402 on a dynamic mesh sequence using an encoder. The encoder can be represented by, or executed by, the server 200 shown in FIG. 2 or the electronic device 300 shown in FIG. 3. A base mesh, which typically has a smaller number of vertices compared to the original base mesh, is created via the pre-processing 402. A base mesh encoder 404 is used to quantize and compress the base mesh in either a lossy or lossless manner, and the base mesh is encoded as a compressed base mesh sub-bitstream. The base mesh can be intra coded (no prediction from neighboring base mesh frames) or inter coded (predicted from neighboring base mesh frames).

The base mesh can then be reconstructed, providing a reconstructed base mesh. This reconstructed base mesh then undergoes one or more levels of subdivision and a displacement field is created by a displacement encoder 406 for each subdivision representing the difference between the original base mesh and the subdivided reconstructed base mesh. In inter-coding of a mesh frame, the base mesh is coded by sending vertex motions instead of compressing the base mesh directly. In either case, a displacement field is created. Each displacement of the displacement field has three components, denoted by x, y, and z. These may be with respect to a canonical coordinate system or a local coordinate system where x, y, and z represent the displacement in local normal, tangent, and bi-tangent directions. As shown in FIG. 4, a displacement sub-bitstream is provided by the displacement encoder 406.

As also shown in FIG. 4, an attribute transfer operation can be performed using an video encoder 408. The video encoder 408 can use a deformed mesh, a static/dynamic mesh, and an attribute map to create an attribute sub-bitstream. A point cloud is a set of 3D points along with attributes such as color, normals, reflectivity, point-size, etc. that represent an object's surface or volume. These attributes are encoded as a compressed attribute bitstream. The encoding of the compressed attribute sub-bitstream may also include a padding operation, a color space conversion operation, and a video encoding operation. In various embodiments, an atlas can also be encoded as a compressed atlas sub-bitstream using an atlas encoder 410. The atlas component provides information to a decoding and/or rendering system on how to perform inverse reconstruction. For example, the atlas can provide information on how to perform the subdivision of a base mesh, how to apply the displacement vectors to the subdivided mesh vertices, and how to apply attributes to the reconstructed mesh.

Each of the sub-bitstreams are provided to a multiplexer 412. The multiplexer 412 multiplexes the sub-bitstreams and outputs a compressed bitstream (e.g., a V3C bitstream) that can, for example, be transmitted to, and decoded by, an electronic device such as the server 104 or the client devices 106-116. As shown in FIG. 4, the output compressed bitstream can include the compressed atlas bitstream, the compressed base mesh bitstream, the compressed displacements bitstream, and the compressed attribute bitstream as sub-bitstreams of the compressed bitstream.

Although FIG. 4 illustrates one example encoding process 400, various changes may be made to FIG. 4. For example, the number and placement of various components of the encoding process 400 can vary as needed or desired. In addition, the encoding process 400 may be used in any other suitable process and is not limited to the specific processes described above.

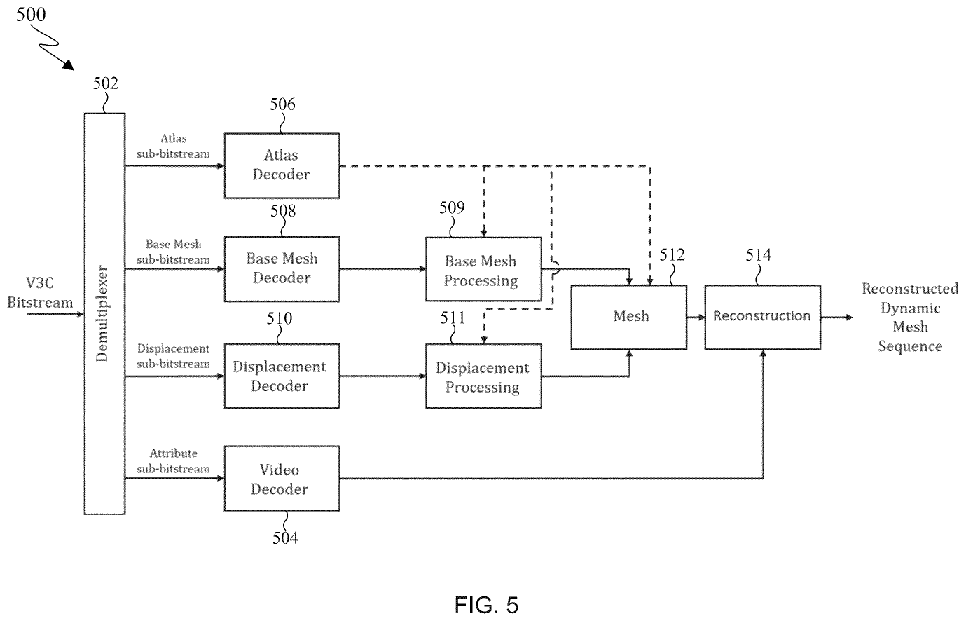

FIG. 5 illustrates an example mesh frame decoding process 500 in accordance with this disclosure. The decoding process 500 illustrated in FIG. 5 is for illustration only. FIG. 5 does not limit the scope of this disclosure to any particular implementation of a mesh frame decoding process. For ease of explanation, the process 500 of FIG. 5 may be described as being performed using the electronic device 300 of FIG. 3. However, the process 500 may be used with any other suitable system and any other suitable electronic device.

The decoding process 500 involves a demultiplexer 502 of a decoder that receives an incoming bitstream, e.g., the bitstream output by the encoder of the process 400 of FIG. 4. The demultiplexer 502 separates out the various component sub-bitstreams from the incoming bitstream, including the compressed base mesh sub-bitstream, the compressed displacement sub-bitstream, the compressed attribute sub-bitstream, and the atlas sub-bitstream, such as described with respect to FIG. 4. The compressed attribute sub-bitstream is decoded using a video decoder 504, the decoded attributes are processed using a color space conversion operation, and the original attributes for the mesh are recovered. The decoding process also can include processing the atlas sub-bitstream using an atlas decoder 506 to obtain the atlas data for the base mesh. The atlas sub-bitstream can be decoded to obtain an atlas that provides information on how to perform inverse reconstruction. For example, the atlas can provide information on how to perform the subdivision of a base mesh, how to apply the displacement vectors to the subdivided mesh vertices, and how to apply attributes to the reconstructed mesh.

The decoding process 500 also includes processing the base mesh sub-stream using a base mesh decoder 508. The base mesh decoder 508 decodes the base mesh sub-bitstream to form a reconstructed base mesh 512. A base mesh processing operation 509 is used with a displacement processing operation 511 to apply subdivision to the reconstructed base mesh 512. Particularly, the decoding process 500 includes decoding the displacements sub-bitstream using a displacement decoder 510, which can, in some embodiments, be the same decoder as the video decoder 504. The decoded displacements data can undergo an image unpacking operation, an inverse quantization operation, and an inverse wavelet transform operation, as part of recovering the positions displacements data. Recovering the positions displacements data can also include performing using displacement processing operation 511 on the mesh frames recovered using a base mesh decoder 508, and extracting x, y, z components (normal, tangent, bitangent) from the subdivided mesh frames. The received displacement field is decompressed and added to the reconstructed base mesh 512 as part of a reconstruction operation 514 to generate a final reconstructed mesh in the decoder, e.g., the reconstructed dynamic mesh sequence shown in FIG. 5.

Although FIG. 5 illustrates one example frame decoding process 500, various changes may be made to FIG. 5. For example, the number and placement of various components of the decoding process 500 can vary as needed or desired. In addition, the decoding process 500 may be used in any other suitable process and is not limited to the specific processes described above. Also, while shown as a series of steps, various steps in FIG. 5 may overlap, occur in parallel, or occur any number of times.

Various standards have been proposed with respect to vertex mesh and dynamic mesh coding. The following documents are hereby incorporated by reference in their entirety as if fully set forth herein:
“V-DMC TMM 9.0, ISO/IEC SC29 WG07 N00951, September 2024; and Study of technologies for Video-based mesh coding, ISO/IEC SC29 WG07 N00960, August 2024

As noted herein, a base mesh can be intra-coded (no prediction from neighboring base mesh frames) or inter-coded (predicted from neighboring base mesh frames). This disclosure provides various improvements to inter-coding of base meshes. In inter-coding, the vertex positions of the current frame are predicted from corresponding vertex position in a reference frame(s). The connectivity is assumed to be identical with the connectivity in the reference frame(s). In some cases, a reference frame can have duplicate vertices. A vertex is defined as a duplicate vertex if its position is identical to the position of another vertex that occurs earlier in the scan order through the vertices.

Existing approaches use motion vector signaling where, for each non-duplicate vertex in the reference frame, a motion vector is always signaled. For each duplicate vertex in the reference frame, a flag is sent to indicate whether a motion vector is explicitly signaled for that vertex.

Existing syntax, semantics and decoding processes related to motion vectors for vertices are as follows in Table 1.

TABLE 1
Base mesh inter submesh data unit syntax

| | Descriptor |
|---|---|
| bm_inter_submesh_data_unit_default ( submeshID ) { | |
| bmidu_{—}vertex_{—}count[ submeshID ] | vu(v) |
| vertexCount = bmidu_vertex_count[ submeshID ] | |
| bmidu_{—}mv_{—}signalled_{—}flag_{—}last1pos[ subMeshID ] | ae(v) |
| for( d = 0, NoSignalledMvCount = 0; | |
| d < bmidu_mv_signalled_flag_last1pos[ subMeshID ]; d++ ) { | |
| bmidu_{—}mv_{—}signalled_{—}flag[ subMeshID ][ d ] | ae(v) |
| if( !bmidu_mv_signalled_flag[ subMeshID ][ d ] ) | |
| NoSignalledMvCount++ | |
| } | |
| bmidu_{—}mv_{—}signalled_{—}flag_{—}trailing0[ subMeshID ] | ae(v) |
| NoSignalledMvCount += bmidu_mv_signalled_flag_trailing0[ subMeshID ] | |
| vertexCount = vertexCount − NoSignalledMvCount | |
| groupSize = bmsps_inter_mesh_motion_group_size_minus1 + 1 | |
| groupCount = ( vertexCount − 1) / groupSize + 1 | |
| ... | |
| } | |

Here, the syntax elements bmidu_mv_signalled_flag_last1pos[subMeshID] and bmidu_mv_signalled_flag_trailing0[subMeshID], together, signal whether a motion vector is signaled for each duplicate vertex in the reference frame.

The corresponding semantics are as follows:

### H.8.5.1.4 Base Mesh Profile Toolset Constraints Information Semantics

. . .
bmptc_motion_vector_derivation_disable_flag equal to 1 specifies the motion vector derivation is disabled. When bmptc_motion_vector_derivation_disable_flag equal to 1, bmidu_mv_signalled_flag_last1pos[i] is always 0 for any possible submesh with submeshID i. When bmptc_motion_vector_derivation_disable_flag is not present, bmptc_motion_vector_derivation_disable_flag is inferred to be equal to 0.
. . .

### H.8.5.8.1 Base Mesh Inter Submesh Data Unit Default Semantics

. . .
bmidu_mv_signalled_flag_last1pos[submeshID] specifies the number of bmidu_mv_signalled_flag in the current submesh, with submesh ID equal to submeshID.
bmidu_mv_signalled_flag_trailing0[submeshID] specifies that bmidu_mv_signalled_flag_trailing0 BmiduMvFlag values are derived to be equal to 0 in the current submesh, with submesh ID equal to submeshID.
. . .
bmidu_mv_signalled_flag[submeshID][d] indicates a motion vector for the vertex with index d, whose output of findIndexInArray( ) is not −1, is present in the bitstream. bmidu_mv_signalled_flag[submeshID][d] is used to derive BmiduMvFlag [submeshID][v] variable, which indicates that a motion vector for the vertex with index v is present in the bitstream.

The BmiduMvFlag [submeshID][v] variable is derived as follows:

```
  d = 0
  for( v = 0; v < vertexCount; v++ ) {
    vRef = findIndexInArray( referenceSubmeshVertexPositions[ v ],
      referenceSubmeshVertexPositions, v − 1 )
    if( vRef != −1 ) {
      if( d < bmidu_mv_signalled_flag_last1pos[ submeshID ] )
BmiduMvFlag[ submeshID ][ v ] = bmidu_mv_signalled_flag[ submeshID ][ d ]
      else
        BmiduMvFlag[ submeshID ][ v ] = 0
      d++
    }else {
      BmiduMvFlag[ submeshID ][ v ] = 1
    }
  }
where findIndexInArray( ) function is defined in subclause H.5
```

The structure bimdu_mv_signalled_flag[d] stores the value of the flag duplicate vertex with index d. The syntax elements bimdu_mv_signalled_flag_last1pos indicates the position of the last duplicate vertex for which motion vector is explicitly signalled. The syntax elements bimdu_mv_signalled_flag_trailing0 indicates the number of duplicate vertices following the last1pos for which no motion vector is signalled. The number of motion vectors that are parsed from the bitstream depend on the number of zeroes in bimdu_mv_signalled_flag, the number of vertices in the submesh and the value of bimdu_mv_signalled_flag_trailing0.

This disclosure provides various ways in which the above inter-coding could be improved. Throughout this disclosure, changes to the existing inter-coding elements are shown inside bolded double brackets to show deletions. Additions are shown inside double dashes (--).

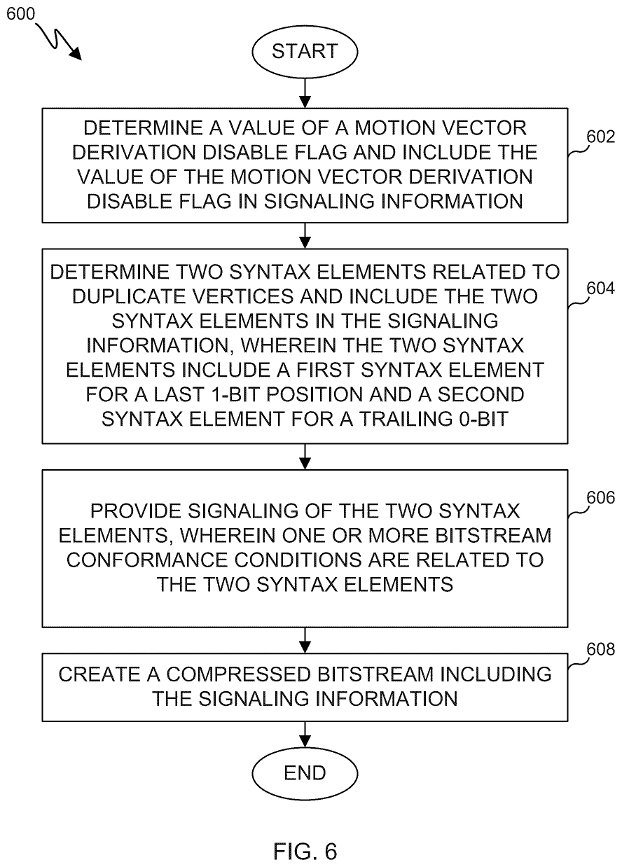

FIG. 6 illustrates an example encoding method 600 in accordance with this disclosure. For ease of explanation, the method 600 of FIG. 6 is described as being performed using the electronic device 300 of FIG. 3. However, the method 600 may be used with any other suitable system and any other suitable electronic device.

The method 600 can be performed as part of creating a compressed bitstream having a base mesh sub-bitstream, such as that described with respect to FIG. 4. As shown in FIG. 6, at step 602, and as also described with respect to FIG. 4, the electronic device 300 determines a value of a motion vector derivation disable flag and includes the value of the motion vector derivation disable flag in signaling information. At step 604, the electronic device determines two syntax elements related to duplicate vertices and include the two syntax elements in the signaling information, where the two syntax elements include a first syntax element for a last 1-bit position and a second syntax element for a trailing 0-bit.

At step 606, the electronic device 300 can provide signaling of the two syntax elements, where one or more bitstream conformance conditions are related to the two syntax elements. For example, a conformance condition can be that, when a motion vector derivation disable flag is equal to 1, the two syntax elements are always zero. A conformance condition can also be that the sum of the two syntax elements is equal to, or, in some embodiments, is less than or equal to, the number of duplicate vertices in the reference submesh.

At step 608, the electronic device 300 creates the compressed bitstream including the signaling information. As described in this disclosure, the compressed bitstream can be multiplexed to include sub-bitstreams such as an atlas sub-bitstream, a base mesh sub-bitstream, a displacement sub-bitstream, and an attribute sub-bitstream. The output compressed bitstream can be transmitted to an external device or to a storage on the electronic device 300.

Although FIG. 6 illustrates one example of an encoding method 600, various changes may be made to FIG. 6. For example, while shown as a series of steps, various steps in FIG. 6 may overlap, occur in parallel, or occur any number of times. For example, in some embodiments, as also described in this disclosure, instead of using conformance conditions, conditional signaling of the two syntax elements can be used. For example, when using conditional signaling, in the syntax table, bmidu_mv_signalled_flag_last1pos[i] and bmidu_mv_signalled_flag_trailing0[i] are signaled only when bmptc_motion_vector_derivation_disable_flag is equal to 1. In this case, the semantics state a default value of 0 for bmidu_mv_signalled_flag_last1pos[i] and bmidu_mv_signalled_flag_trailing0[i] when they are not present. This alternative method can be used to achieve the same effect as the conformance condition.

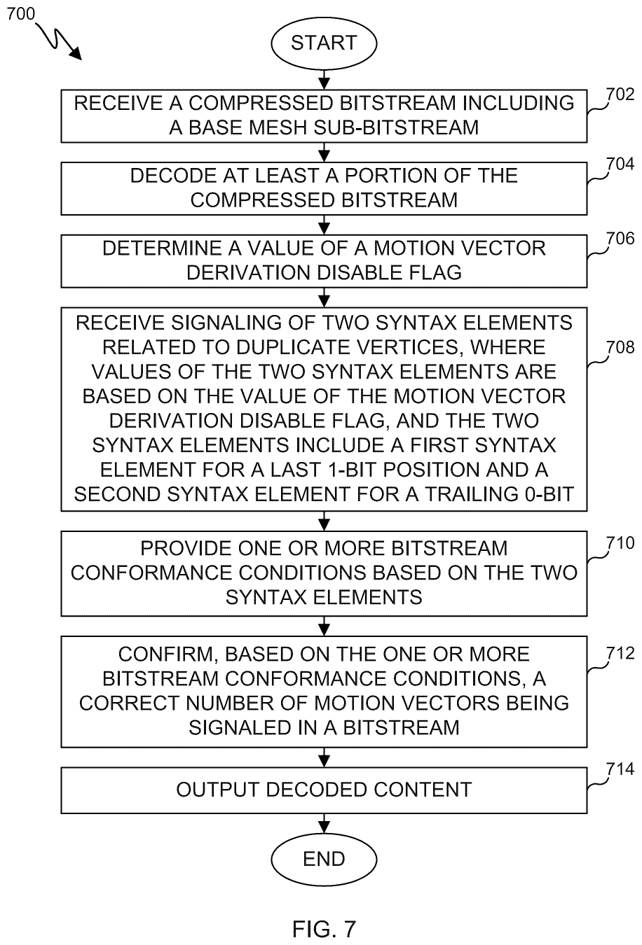

These conformance conditions can also be used during decoding. For instance, FIG. 7 illustrates an example decoding method 700 in accordance with this disclosure. For ease of explanation, the method 700 of FIG. 7 is described as being performed using the electronic device 300 of FIG. 3. However, the method 700 may be used with any other suitable system and any other suitable electronic device.

As shown in FIG. 7, at step 702, the electronic device 300 receives a compressed bitstream including a base mesh sub-bitstream, such as described with respect to FIG. 5. At step 704, the electronic device 300 decodes at least a portion of the compressed bitstream. At step 706, the electronic device 300 determines a value of a motion vector derivation disable flag in the signaling information.

At step 708 signaling of two syntax elements related to duplicate vertices is received by the decoder. The values of the two syntax elements are based on the value of the motion vector derivation disable flag. The two syntax elements can include a first syntax element for a last 1-bit position and a second syntax element for a trailing 0-bit. At step 710, the electronic device 300 provides one or more bitstream conformance conditions based on the two syntax elements.

At step 712, the electronic device 300 confirms, based on the one or more bitstream conformance conditions, a correct number of motion vectors being signaled in a bitstream. For example, in some embodiments, the bitstream conformance conditions can include that, when bmptc_motion_vector_derivation_disable_flag is equal to 1, it is a requirement of bitstream conformance that bmidu_mv_signalled_flag_last1pos[i] and bmidu_mv_signalled_flag_trailing0[i] are is always 0. In some embodiments, a requirement of bitstream conformance can be that the sum of mcp_mv_signalled_flag_count and mcp_mv_signalled_flag_trailing0 is less than or equal to the number of duplicate vertices in the reference submesh. The decoder receiving the bitstream is thus able to verify these conformance conditions, as bmidu_mv_signalled_flag_last1pos[i] and bmidu_mv_signalled_flag_trailing0[i] are always signaled.

The corresponding semantics can also specify the ranges. For instance, a mcp_mv_signalled_flag_count specifies the number of mcp_mv_signalled_flag[d] present in the bitstream. In various embodiments, the value of mcp_mv_signalled_flag_count shall be in the range of 0 to (mcp_vertex_count−1), inclusive. Additionally, mcp_mv_signalled_flag_trailing0 specifies the number of mcp_mv_signalled_flag[d] not present in the bitstream and assumed to be equal to 0. In various embodiments, the value of mcp_mv_signalled_flag_trailing0 shall be in the range of 0 to (mcp_vertex_count−mcp_mv_signalled_flag_count−1), inclusive.

At step 714, the electronic device 300 outputs decoded content using a reconstructed base mesh, such as 3D video including a reconstructed mesh-frame, where the base mesh is reconstructed based on the conformance conditions. The output decoded content can be transmitted to an external device or to a storage on the electronic device 300, for instance.

Although FIG. 7 illustrates one example of a decoding method 700, various changes may be made to FIG. 7. For example, while shown as a series of steps, various steps in FIG. 7 may overlap, occur in parallel, or occur any number of times. For example, in some embodiments, as also described in this disclosure, instead of using conformance conditions, conditional signaling of the two syntax elements can be used. For example, when using conditional signaling, in the syntax table, bmidu_mv_signalled_flag_last1pos[i] and bmidu_mv_signalled_flag_trailing0[i] are signaled only when bmptc_motion_vector_derivation_disable_flag is equal to 1. In this case, the semantics state a default value of 0 for bmidu_mv_signalled_flag_last1pos[i] and bmidu_mv_signalled_flag_trailing0[i] when they are not present. This alternative method can be used to achieve the same effect as the conformance condition.

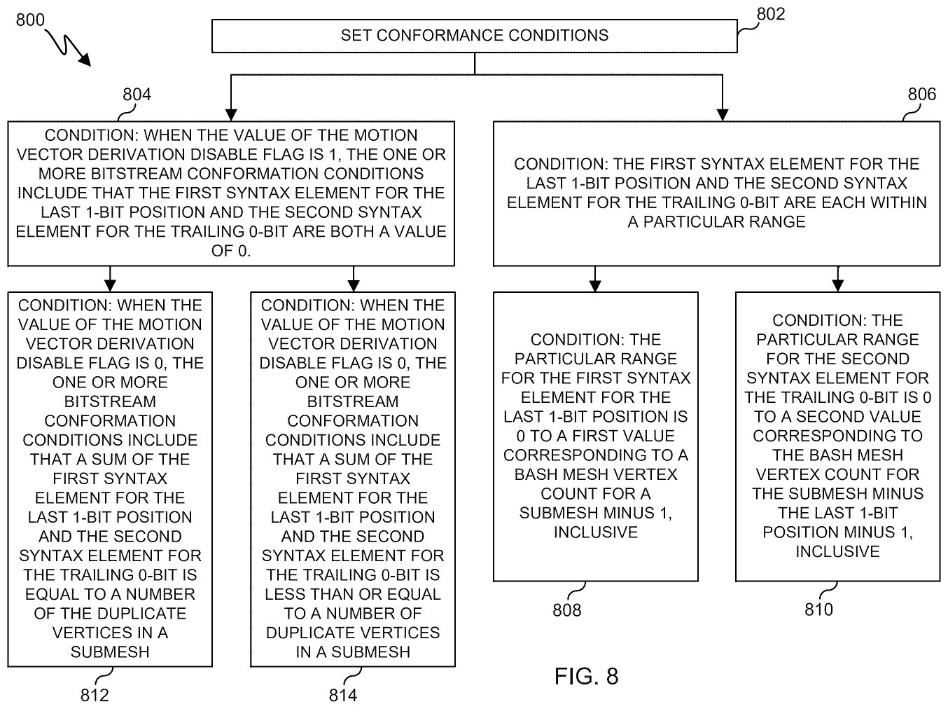

As noted above, the conformance conditions can be associated with syntax elements related to duplicate vertices that are signaled in the bitstream. The two syntax elements can include a first syntax element for a last 1-bit position and a second syntax element for a trailing 0-bit, i.e., the bmidu_mv_signalled_flag_last1pos and bimdu_mv_signalled_flag_trailing0 syntax elements. FIG. 8 illustrates an example method 800 of setting conformance conditions in accordance with this disclosure. For ease of explanation, the method 800 of FIG. 8 is described as being performed using the electronic device 300 of FIG. 3. However, the method 800 may be used with any other suitable system and any other suitable electronic device.

At step 802, one or more conformance conditions are set. This disclosure provides various conformance conditions as detailed below and as shown in steps 804-814 of FIG. 8.

For example, at step 804, a conformance condition can be that, when the value of the motion vector derivation disable flag is 1, the one or more bitstream conformation conditions include that the first syntax element for the last 1-bit position and the second syntax element for the trailing 0-bit are both a value of 0. That is, in existing semantics of bmptc_motion_vector_derivation_disable_flag, when the flag is 1, bmidu_mv_signalled_flag_last1pos[submeshID] is always 0 for any possible submesh with submeshID i. But embodiments of this disclosure modify this language to indicate clear conformance conditions on bmidu_mv_signalled_flag_last1pos and bimdu_mv_signalled_flag_trailing0 when bmptc_motion_vector_derivation_disable_flag is equal to 1.

Thus, in some embodiments, the semantics of bmptc_motion_vector_derivation_disable_flag is modified as follows:
bmptc_motion_vector_derivation_disable_flag equal to 1 specifies the motion vector derivation is disabled.
When bmptc_motion_vector_derivation_disable_flag equal to 1, —it is a requirement of bitstream conformance that—[[if]] bmidu_mv_signalled_flag_last1pos[i] is always 0 for any possible submesh with submeshID i. When bmptc_motion_vector_derivation_disable_flag is not present, bmptc_motion_vector_derivation_disable_flag is inferred to be equal to 0.

Furthermore, the same condition can be imposed on bmidu_mv_signalled_flag_trailing0[submeshID]. This is because if bmidu_mv_signalled_flag_trailing0[submeshID] is greater than 0, the decoder needs to determine duplicate vertices. This is contrary to the idea that no duplicate vertex determination should be necessary when bmptc_motion_vector_derivation_disable_flag is equal to 1. Thus, in some embodiments, the semantics of bmptc_motion_vector_derivation_disable_flag is modified as follows:
bmptc_motion_vector_derivation_disable_flag equal to 1 specifies the motion vector derivation is disabled.
When bmptc_motion_vector_derivation_disable_flag equal to 1, —it is a requirement of bitstream conformance that—[[if] bmidu_mv_signalled_flag_last1pos[i]—and bmidu_mv_signalled_flag_trailing0[i] are—[is]] always 0 for any possible submesh with submeshID i. When bmptc_motion_vector_derivation_disable_flag is not present, bmptc_motion_vector_derivation_disable_flag is inferred to be equal to 0.

In some embodiments, instead of the bitstream conformance conditions in the semantics, the signalling of bmidu_mv_signalled_flag_last1pos[submeshID] and bmidu_mv_signalled_flag_trailing0[submeshID] is made conditional on bmptc_motion_vector_derivation_disable_flag being 0. The syntax and semantics are modified as follows in Table 2 and the following syntax and semantics recitation:

TABLE 2
Base mesh inter submesh data unit syntax

| | Descriptor |
|---|---|
| bm_inter_submesh_data_unit_default ( submeshID ) { | |
| bmidu_{—}vertex_{—}count[ submeshID ] | vu(v) |
| vertexCount = bmidu_vertex_count[ submeshID ] | |
| −−if(!bmptc_motion_vector_derivation_disable_flag)−− | |
| bmidu_{—}mv_{—}signalled_{—}flag_{—}last1pos[ subMeshID ] | ae(v) |
| for( d = 0, NoSignalledMvCount = 0; | |
| d < bmidu_mv_signalled_flag_last1pos[ subMeshID ]; d++ ) { | |
| bmidu_{—}mv_{—}signalled_{—}flag[ subMeshID ][ d ] | ae(v) |
| if( !bmidu_mv_signalled_flag[ subMeshID ][ d ] ) | |
| NoSignalledMvCount++ | |
| } | |
| −−if(!bmptc_motion_vector_derivation_disable_flag)−− | |
| bmidu_{—}mv_{—}signalled_{—}flag_{—}trailing0[ subMeshID ] | ae(v) |
| NoSignalledMvCount += bmidu_mv_signalled_flag_trailing0[ subMeshID ] | |
| vertexCount = vertexCount − NoSignalledMvCount | |
| groupSize = bmsps_inter_mesh_motion_group_size_minus1 + 1 | |
| groupCount = ( vertexCount − 1) / groupSize + 1 | |
| ... | |
| } | |

### H.8.5.1.4 Base Mesh Profile Toolset Constraints Information Semantics

. . .
bmptc_motion_vector_derivation_disable_flag equal to 1 specifies the motion vector derivation disabled. [[When is bmptc_motion_vector_derivation_disable_flag equal to 1, bmidu_mv_signalled_flag_last1pos[i] is always 0 for any possible submesh with submeshID i.]] When bmptc_motion_vector_derivation_disable_flag is not present, bmptc_motion_vector_derivation_disable_flag is inferred to be equal to 0.
. . .

### H.8.5.8.1 Base Mesh Inter Submesh Data Unit Default Semantics

. . .
bmidu_mv_signalled_flag_last1pos[submeshID] specifies the number of bmidu_mv_signalled_flag in the current submesh, with submesh ID equal to submeshID.
—When bmidu_mv_signalled_flag_last1pos[submeshID] is not present, it is inferred to be equal to 0.—
bmidu_mv_signalled_flag_trailing0[submeshID] specifies that bmidu_mv_signalled_flag_trailing0 BmiduMvFlag values are derived to be equal to 0 in the current submesh, with submesh ID equal to submeshID.
—When bmidu_mv_signalled_flag_trailing0[submeshID] is not present, it is inferred to be equal to 0.—
. . .

Since it is a requirement of bitstream conformance that (bmidu_mv_signalled_flag_last1pos+bmidu_mv_signalled_flag_trailing0) is less than bmidu_vertex_count, bmidu_mv_signalled_flag_last1pos and bmidu_mv_signalled_flag_trailing0 have to satisfy:
0<=bmidu_mv_signalled_flag_last1pos[submeshID]<bmidu_vertex_count[submeshID] and
0<=bmidu_mv_signalled_flag_trailing[submeshID]<bmidu_vertex_count[submeshID].

Thus, in some embodiments, as shown in FIG. 8, a conformance condition, shown at step 806, can include that the first syntax element for the last 1-bit position and the second syntax element for the trailing 0-bit are each within a particular range. For example, the semantics bmidu_mv_signalled_flag_last1pos[submeshID] and bmidu_mv_signalled_flag_trailing0[submeshID] can be modified to reflect the valid ranges.

In various embodiments, as shown at step 808, the particular range for the first syntax element for the last 1-bit position can be set to be 0 to a first value corresponding to a bash mesh vertex count for a submesh minus 1, inclusive. In various embodiments, as shown at step 810, the particular range for the second syntax element for the trailing 0-bit can be set to be 0 to a second value corresponding to the bash mesh vertex count for the submesh minus the last 1-bit position minus 1, inclusive.

Based on these conformance conditions concerning the ranges, the signalling of bmidu_mv_signalled_flag_trailing0[submeshID] is refined as follows:

TABLE 3
Base mesh inter submesh data unit syntax

| | Descriptor |
|---|---|
| bm_inter_submesh_data_unit_default ( submeshID ) { | |
| bmidu_{—}vertex_{—}count[ submeshID ] | vu(v) |
| vertexCount = bmidu_vertex_count[ submeshID ] | |
| −−if(!bmptc_motion_vector_derivation_disable_flag)−− | |
| bmidu_{—}mv_{—}signalled_{—}flag_{—}last1pos[ subMeshID ] | ae(v) |
| for( d = 0, NoSignalledMvCount = 0; | |
| d < bmidu_mv_signalled_flag_last1pos[ subMeshID ]; d++ ) { | |
| bmidu_{—}mv_{—}signalled_{—}flag[ subMeshID ][ d ] | ae(v) |
| if( !bmidu_mv_signalled_flag[ subMeshID ][ d ] ) | |
| NoSignalledMvCount++ | |
| } | |
| −−if((!bmptc_motion_vector_derivation_disable_flag) && | |
| (bmidu_mv_signalled_flag_last1pos[ subMeshID ] < | |
| (bmidu_vertex_count[ submeshID ]−1)))−− | |
| bmidu_{—}mv_{—}signalled_{—}flag_{—}trailing0[ subMeshID ] | ae(v) |
| NoSignalledMvCount += bmidu_mv_signalled_flag_trailing0[ subMeshID ] | |
| vertexCount = vertexCount − NoSignalledMvCount | |
| groupSize = bmsps_inter_mesh_motion_group_size_minus1 + 1 | |
| groupCount = ( vertexCount − 1) / groupSize + 1 | |
| ... | |
| } | |

### H.8.5.1.4 Base Mesh Profile Toolset Constraints Information Semantics

. . .
bmptc_motion_vector_derivation_disable_flag equal to 1 specifies the motion vector derivation is disabled. [[When bmptc_motion_vector_derivation_disable_flag equal to 1, bmidu_mv_signalled_flag_last1pos[i] is always 0 for any possible submesh with submeshID i.]] When bmptc_motion_vector_derivation_disable_flag is not present, bmptc_motion_vector_derivation_disable_flag is inferred to be equal to 0.

### H.8.5.8.1 Base Mesh Inter Submesh Data Unit Default Semantics

. . .
bmidu_mv_signalled_flag_last1pos[submeshID] specifies the number of bmidu_mv_signalled_flag in the current submesh, with submesh ID equal to submeshID.
—The value of bmidu_mv_signalled_flag_last1pos[submeshID] shall be in the range of 0 to (bmidu_vertex_count[submeshID]−1), inclusive. When bmidu_mv_signalled_flag_last1pos[submeshID] is not present, it is inferred to be equal to 0.—
bmidu_mv_signalled_flag_trailing0[submeshID] specifies that bmidu_mv_signalled_flag_trailing0 BmiduMvFlag values are derived to be equal to 0 in the current submesh, with submesh ID equal to submeshID.
—The value of bmidu_mv_signalled_flag_trailing0[submeshID] shall be in the range of 0 to (bmidu_vertex_count [submeshID]−1), inclusive. When bmidu_mv_signalled_flag_trailing0[submeshID] is not present, it is inferred to be equal to 0.—
. . .

In some embodiments, the range of bmidu_mv_signalled_flag_trailing0 is further tightened based on the value of bmidu_mv_signalled_flag_last1pos as follows:

$$0 <= bmidu\_mv \_signalled \_flag \_last1pos [ submeshID ] < bmidu\_vertex \_count [ submeshID ]$$

$$and$$

$$0 <= bmidu\_mv \_signalled \_flag \_trailing [ submeshID ] < ( bmidu\_vertex \_count [ submeshID ] - bmidu\_mv \_signalled \_flag \_last1pos [ submeshID ] ) .$$

Thus, in various embodiments of this disclosure, the conformance condition on the sum of bmidu_mv_signalled_flag_last1pos and bmidu_mv_signalled_flag_trailing0 can be eliminated.

### H.8.5.8.1 Base Mesh Inter Submesh Data Unit Default Semantics

. . .
bmidu_mv_signalled_flag_last1pos[submeshID] specifies the number of bmidu_mv_signalled_flag in the current submesh, with submesh ID equal to submeshID.
—The value of bmidu_mv_signalled_flag_last1pos[submeshID] shall be in the range of 0 to (bmidu_vertex_count [submeshID]−1), inclusive.—
bmidu_mv_signalled_flag_trailing0[submeshID] specifies that bmidu_mv_signalled_flag_trailing0 BmiduMvFlag values are derived to be equal to 0 in the current submesh, with submesh ID equal to submeshID.
—The value of bmidu_mv_signalled_flag_trailing0[submeshID] shall be in the range of 0 to (bmidu_vertex_count [submeshID]−bmidu_mv_signalled_flag_last1pos[submeshID]−1), inclusive.—
It is a requirement of bitstream conformance that if bmidu_mv_signalled_flag_last1pos[submeshID] plus bmidu_mv_signalled_flag_trailing0[submeshID] is larger than 0 for a submesh with submesh ID equal to submeshID, mesh_deduplicate_method, if present in the corresponding intra submesh data unit, shall be equal to MESH_POSITION_DEDUP_NONE.
[[It is a requirement of bitstream conformance that bmidu_mv_signalled_flag_last1pos[submeshID] plus bmidu_mv_signalled_flag_trailing0[submeshID] is smaller than bmidu_vertex_count[submeshID].]]
   . . .

In some embodiments, the above elimination of the conformance condition on the sum of bmidu_mv_signalled_flag_last1pos and bmidu_mv_signalled_flag_trailing0 can be combined with conditional signalling of bmidu_mv_signalled_flag_last1pos and bmidu_mv_signalled_flag_trailing0 based on the value of bmptc_motion_vector_derivation_disable_flag, such as shown in Table 4 below and the following syntax:

TABLE 4
Base mesh inter submesh data unit syntax

| | Descriptor |
|---|---|
| bm_inter_submesh_data_unit_default ( submeshID ) { | |
| bmidu_{—}vertex_{—}count[ submeshID ] | vu(v) |
| vertexCount = bmidu_vertex_count[ submeshID ] | |
| −−if(!bmptc_motion_vector_derivation_disable_flag)−− | |
| bmidu_{—}mv_{—}signalled_{—}flag_{—}last1pos[ subMeshID ] | ae(v) |
| for( d = 0, NoSignalledMvCount = 0; | |
| d < bmidu_mv_signalled_flag_last1pos[ subMeshID ]; d++ ) { | |
| bmidu_{—}mv_{—}signalled_{—}flag[ subMeshID ][ d ] | ae(v) |
| if( !bmidu_mv_signalled_flag[ subMeshID ][ d ] ) | |
| NoSignalledMvCount++ | |
| } | |
| −−if(!bmptc_motion_vector_derivation_disable_flag)−− | |
| bmidu_{—}mv_{—}signalled_{—}flag_{—}trailing0[ subMeshID ] | ae(v) |
| NoSignalledMvCount += bmidu_mv_signalled_flag_trailing0[ subMeshID ] | |
| vertexCount = vertexCount − NoSignalledMvCount | |
| groupSize = bmsps_inter_mesh_motion_group_size_minus1 + 1 | |
| groupCount = ( vertexCount − 1) / groupSize + 1 | |
| ... | |
| } | |

### H.8.5.1.4 Base Mesh Profile Toolset Constraints Information Semantics

. . .
bmptc_motion_vector_derivation_disable_flag equal to 1 specifies the motion vector derivation is disabled. [[When bmptc_motion_vector_derivation_disable_flag equal to 1, bmidu_mv_signalled_flag_last1pos[i] is always 0 for any possible submesh with submeshID i.]] When bmptc_motion_vector_derivation_disable_flag is not present, bmptc_motion_vector_derivation_disable_flag is inferred to be equal to 0.

### H.8.5.8.1 Base Mesh Inter Submesh Data Unit Default Semantics

. . .
bmidu_mv_signalled_flag_last1pos[submeshID] specifies the number of bmidu_mv_signalled_flag in the current submesh, with submesh ID equal to submeshID.
—The value of bmidu_mv_signalled_flag_last1pos[submeshID] shall be in the range of 0 to (bmidu_vertex_count[submeshID]−1), inclusive. When bmidu_mv_signalled_flag_last1pos[submeshID] is not present, it is inferred to be equal to 0.—
bmidu_mv_signalled_flag_trailing0[submeshID] specifies that bmidu_mv_signalled_flag_trailing0 BmiduMvFlag values are derived to be equal to 0 in the current submesh, with submesh ID equal to submeshID.
—The value of bmidu_mv_signalled_flag_trailing0[submeshID] shall be in the range of 0 to (bmidu_vertex_count[submeshID]-bmidu_mv_signalled_flag_last1pos[submeshID]−1), inclusive. When bmidu_mv_signalled_flag_trailing0[submeshID] is not present, it is inferred to be equal to 0.—
It is a requirement of bitstream conformance that if bmidu_mv_signalled_flag_last1pos[submeshID] plus bmidu_mv_signalled_flag_trailing0[submeshID] is larger than 0 for a submesh with submesh ID equal to submeshID, mesh_deduplicate_method, if present in the corresponding intra submesh data unit, shall be equal to MESH_POSITION_DEDUP_NONE.

[[It is a requirement of bitstream conformance that bmidu_mv_signalled_flag_last1pos[submeshID] plus bmidu_mv_signalled_flag_trailing0[submeshID] is smaller than bmidu_vertex_count [submeshID].]]

. . .

It may happen that the number signalled motion vectors may not match the number of entries with value 1 in BmiduMvFlag [submeshID][v] if the sum of bmidu_mv_signalled_flag_last1pos and bmidu_mv_signalled_flag_trailing0 is not exactly equal to the number of duplicate vertices. Consider the following example:

Suppose that there are 50 total vertices and 7 duplicate vertices. Suppose that only the motion vectors corresponding to the first and third duplicate vertex need to be sent explicitly. In this case, bmidu_mv_signalled_flag_last1pos would be signalled as 3 and bmidu_mv_signalled_flag array would be [1 0 1]. The syntax element bmidu_mv_signalled_flag_trailing0 should be signalled as 4. In this case, there would be a total of 45 motion vectors signalled (43 motion vectors for non-duplicate vertices+2 motion vectors for duplicate vertices).

However, if an encoder incorrectly signals bmidu_mv_signalled_flag_trailing0 as 6, NoSignalledMvCount will be incremented by 6. Then, the number of motion vectors signalled in the bitstream will be 43 instead of 45. However, the derivation of BmiduMvFlag [submeshID][v] will assign a value of 1 to 45 entries. In this case, when assigning motion vectors to vertices, there will be two vertices which need a motion vector but it is not found in the bitstream.

To avoid this situation, in some embodiments, a bitstream conformance condition can be imposed as shown at step 812 of FIG. 8, such that, when the value of the motion vector derivation disable flag is 0, the one or more bitstream conformation conditions include that a sum of the first syntax element for the last 1-bit position and the second syntax element for the trailing 0-bit is equal to a number of the duplicate vertices in a submesh. This bitstream conformance condition can be imposed after the semantics of bmidu_mv_signalled_flag_trailing0[submeshID] as follows:
bmidu_mv_signalled_flag_trailing0[submeshID] specifies that . . .
—It is a requirement of bitstream conformance that when the value of bmptc_motion_vector_derivation_disable_flag is equal to 0, the sum of bmidu_mv_signalled_flag_last1pos[submeshID] and bmidu_mv_signalled_flag_trailing0[submeshID] is equal to the number of duplicate vertices in the reference submesh of the submesh with submesh ID equal to submeshID.—
. . .

In some embodiments, a slightly weaker bitstream conformance condition can be imposed, as shown at step 814 of FIG. 8, such that, when the value of the motion vector derivation disable flag is 0, the one or more bitstream conformation conditions include that a sum of the first syntax element for the last 1-bit position and the second syntax element for the trailing 0-bit is less than or equal to a number of duplicate vertices in the reference submesh. This is shown as follows:
bmidu_mv_signalled_flag_trailing0[submeshID] specifies that . . .
—It is a requirement of bitstream conformance that when the value of bmptc_motion_vector_derivation_disable_flag is equal to 0, the sum of bmidu_mv_signalled_flag_last1pos[submeshID] and bmidu_mv_signalled_flag_trailing0[submeshID] is less than or equal to the number of duplicate vertices in the reference submesh of the submesh with submesh ID equal to submeshID.—
. . .

The “less than or equal to” condition implies that it is possible for the bitstream to contain an excess number of motion vectors. That is, the number of motion vectors in the bitstream is greater than the number of ones in BmiduMvFlag array. In this case, the excess motion vectors will be discarded by the decoder.

In some embodiments, if the value of BmiduMvFlag[submeshID][v] indicates that a motion vector should be signalled for vertex v, but no motion vector is found in the bitstream, the signalled value is assigned a default of (0, 0, 0).

When the value of bmptc_intra_frames_only_flag is equal to 1, bmsh_type can only be I_SUBMESH. So, in some embodiments, the signaling of bmsh_type is made conditional on bmptc_intra_frames_only_flag. The semantics of bmptc_intra_frames_only_flag and bmsh_type is also modified, as shown in the following Table 5 and the following syntax elements.

TABLE 5
Base mesh submesh header syntax

| | Descriptor |
|---|---|
| bmesh_submesh_header ( ) { | |
| ... | |
| submeshID = bmsh_id | |
| −−If(!bmptc_intra_frames_only_flag)−− | |
| −−bmsh_{—}type−− | −−ue(v)−− |
| ... | |
| byte_alignment( ) | |
| } | |

### H.8.5.4 Base Mesh Submesh Header Semantics

. . .
bmsh_type specifies the coding type of the current submesh according to Table H-5. The value of bmsh_type shall be equal to 0, 1, or 2 in bitstreams conforming to this version of this document. Other values of bmsh_type are reserved for future use by ISO/IEC. Decoders conforming to this version of this document shall ignore reserved values of bmsh_type.
—When not present, the value of bmsh_type is inferred to be equal to 1.—

Table 6 and the following syntax elements show the name association to the bmsh_type and toolset constraints information semantics.

TABLE 6
Name association to bmsh_type

| bmsh_type | Name of bmsh_type |
|---|---|
| 0 | P_SUBMESH |
| 1 | I_SUBMESH |
| 2 | SKIP_SUBMESH |
| 3- . . . | RESERVED |

### H.8.5.1.4 Base Mesh Profile Toolset Constraints Information Semantics

. . .
bmptc_intra_frames_only_flag equal to 1 specifies that the bitstream
—only contains frames with the value of bmsh_type equal to 1.—
When not present, the—value of—bmptc_intra_frames_only_flag is inferred to be equal to 0.

In the 17^{th} meeting of ISO/IEC SC29 WG07 held in Kemer, Turkiye, November 2024, it was decided to create a separate Annex (Annex L) for the motion codec part of the base mesh codec. The motion codec which is currently part of Annex H will be moved to a new Annex (Annex L). The base mesh codec will have the flexibility of using a different motion codec than the one specified in Annex L.

This disclosure thus proposes changes necessitated by such changes. For example, the syntax elements bmidu_mv_signalled_flag_last1pos and bmidu_mv_signalled_flag_trailing0 will now belong to Annex L. Also, if a motion codec different from that in Annex L is used, those syntax elements will not be present at all. Thus, it may not be appropriate to refer to those syntax elements in the bitstream conformance conditions in Annex H as proposed above.

Therefore, in some embodiments of this disclosure, the bitstream conformance condition can be converted to a profile constraint. For example, when a base mesh profile uses Annex L as the motion codec, the bitstream will satisfy the following constraint:
When bmptc_motion_vector_derivation_disable_flag is equal to 1, the value of syntax elements bmidu_mv_signalled_flag_last1pos and bmidu_mv_signalled_flag_trailing0 shall be equal to 0.

If a separate profile is created which uses Annex L as the motion codec and bmptc_motion_vector_derivation_disable_flag is constrained to be equal to 1, then the profile restriction will simply be that the value of syntax elements bmidu_mv_signalled_flag_last1pos and bmidu_mv_signalled_flag_trailing0 shall be equal to 0.

In some embodiments, the syntax element bmptc_motion_vector_derivation_disable_flag is explicitly passed to Annex L as input during the invocation of motion codec. Or alternatively, all the syntax elements from Annex H are made available to Annex L during invocation of motion codec. In this case, the bitstream conformance condition may be moved to Annex L after the semantics of bmidu_mv_signalled_flag_last1pos and bmidu_mv_signalled_flag_trailing0 as follows:
When bmptc_motion_vector_derivation_disable_flag equal to 1, it is a requirement of bitstream conformance that bmidu_mv_signalled_flag_last1pos and bmidu_mv_signalled_flag_trailing0 are always 0.

In some embodiments, the dependence on bmptc_motion_vector_derivation_disable_flag in the bitstream conformance condition may be eliminated. Consider that the bitstream conformance condition (or profile restriction) that was proposed earlier is included in the specification, which can be expressed as follows. When bmptc_motion_vector_derivation_disable_flag equal to 1, it is a requirement of bitstream conformance that bmidu_mv_signalled_flag_last1pos and bmidu_mv_signalled_flag_trailing0 are always 0. In this case, when bmptc_motion_vector_derivation_disable_flag equal to 1, the sum of bmidu_mv_signalled_flag_last1pos and bmidu_mv_signalled_flag_trailing0 is 0. This satisfies the condition that the sum is less than or equal to the number of duplicate vertices in the reference submesh.

Thus, in various embodiments, the bitstream conformance condition can be simplified as follows:
It is a requirement of bitstream conformance that the sum of bmidu_mv_signalled_flag_last1pos and bmidu_mv_signalled_flag_trailing0 is less than or equal to the number of duplicate vertices in the reference submesh.

Here in the interest of clarity and simplicity, the submesh IDs have been dropped from the syntax elements since Annex L will be invoked separately for each submesh.

In various embodiments, due to moving of the motion codec from Annex H to a separate (Annex L) described above, various syntax elements may be changed. For example, The prefix for all syntax elements can be changed from “bmidu_” to “mcp_.” Also, “mv_signalled_flag_last1pos” can be renamed to “mv_signalled_flag_count,” “bmidu_mv_signalled_flag_last1pos” can be renamed to “mcp_mv_signalled_flag_count,” “bmidu_mv_signalled_flag_trailing0” can be renamed to “mcp_mv_signalled_flag_trailing0,” and “bmidu_mv_signalled_flag” can be renamed to “mcp_mv_signalled_flag.”

For completeness, example conformance conditions based on the above-described conformance conditions, but with the updated syntax elements, are provided as follows.

### L.8.4.3 Motion Coding Payload Semantics

. . .
mcp_mv_signalled_flag_count specifies the number of mcp_mv_signalled_flag[d] present in the bitstream. The value of mcp_mv_signalled_flag_count shall be in the range of 0 to (mcp_vertex_count−1), inclusive.
mcp_mv_signalled_flag[d] equal to 0 indicates that the motion vector for the duplicate vertex with index d is not present in the bitstream.
mcp_mv_signalled_flag[d] equal to 1 indicates that the motion vector for the duplicate vertex with index d is present in the bitstream.
mcp_mv_signalled_flag_trailing0 specifies the number of mcp_mv_signalled_flag[d] not present in the bitstream and assumed to be equal to 0. The value of mcp_mv_signalled_flag_trailing0 shall be in the range of 0 to (mcp_vertex_count−mcp_mv_signalled_flag_count−1), inclusive.
When bmptc_motion_vector_derivation_disable_flag is equal to 1, it is a requirement of bitstream conformance that mcp_mv_signalled_flag_count and mcp_mv_signalled_flag_trailing0 are always 0.
It can further be a requirement of bitstream conformance that the sum of mcp_mv_signalled_flag_count and mcp_mv_signalled_flag_trailing0 is less than or equal to the number of duplicate vertices in the reference submesh.

Thus, it will be understood that the various conformance conditions described herein can be imposed on the bitstream. Although FIG. 8 illustrates one example of method 800 of setting conformance conditions, various changes may be made to FIG. 8. For example, while shown as a series of steps, various steps in FIG. 8 may overlap, occur in parallel, or occur any number of times. It will also be understood that various combinations of the conformance conditions described herein can be imposed on the bitstream.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. An apparatus comprising:
a communication interface configured to receive a compressed bitstream comprising a base mesh sub-bitstream; and
a processor operably coupled to the communication interface, wherein the processor is configured to:
determine a value of a motion vector derivation disable flag;
receive two syntax elements related to duplicate vertices, wherein values of the two syntax elements are based on the value of the motion vector derivation disable flag, and wherein the two syntax elements include a first syntax element for a last 1-bit position and a second syntax element for a trailing 0-bit;
provide one or more bitstream conformance conditions based on the two syntax elements; and
confirm, based on the one or more bitstream conformance conditions, a correct number of motion vectors being signaled in a bitstream.

2. The apparatus of claim 1, wherein, when the value of the motion vector derivation disable flag is 1, the one or more bitstream conformation conditions include that the first syntax element for the last 1-bit position and the second syntax element for the trailing 0-bit are both a value of 0.

3. The apparatus of claim 1, wherein the one or more bitstream conformation conditions include that the first syntax element for the last 1-bit position and the second syntax element for the trailing 0-bit are each within a particular range.

4. The apparatus of claim 3, wherein the particular range for the first syntax element for the last 1-bit position is 0 to a first value corresponding to a bash mesh vertex count for a submesh minus 1, inclusive.

5. The apparatus of claim 4, wherein the particular range for the second syntax element for the trailing 0-bit is 0 to a second value corresponding to the bash mesh vertex count for the submesh minus the last 1-bit position minus 1, inclusive.

6. The apparatus of claim 1, wherein, when the value of the motion vector derivation disable flag is 0, the one or more bitstream conformation conditions include that a sum of the first syntax element for the last 1-bit position and the second syntax element for the trailing 0-bit is equal to a number of the duplicate vertices in a submesh.

7. The apparatus of claim 1, wherein, when the value of the motion vector derivation disable flag is 0, the one or more bitstream conformation conditions include that a sum of the first syntax element for the last 1-bit position and the second syntax element for the trailing 0-bit is less than or equal to a number of duplicate vertices in a submesh.

8. A method comprising:
receiving a compressed bitstream comprising a base mesh sub-bitstream;
determining a value of a motion vector derivation disable flag;
receiving two syntax elements related to duplicate vertices, wherein values of the two syntax elements are based on the value of the motion vector derivation disable flag, and wherein the two syntax elements include a first syntax element for a last 1-bit position and a second syntax element for a trailing 0-bit;
providing one or more bitstream conformance conditions based on the two syntax elements; and
confirming, based on the one or more bitstream conformance conditions, a correct number of motion vectors being signaled in a bitstream.

9. The method of claim 8, wherein, when the value of the motion vector derivation disable flag is 1, the one or more bitstream conformation conditions include that the first syntax element for the last 1-bit position and the second syntax element for the trailing 0-bit are both a value of 0.

10. The method of claim 8, wherein the one or more bitstream conformation conditions include that the first syntax element for the last 1-bit position and the second syntax element for the trailing 0-bit are each within a particular range.

11. The method of claim 10, wherein the particular range for the first syntax element for the last 1-bit position is 0 to a first value corresponding to a bash mesh vertex count for a submesh minus 1, inclusive.

12. The method of claim 11, wherein the particular range for the second syntax element for the trailing 0-bit is 0 to a second value corresponding to the bash mesh vertex count for the submesh minus the last 1-bit position minus 1, inclusive.

13. The method of claim 8, wherein, when the value of the motion vector derivation disable flag is 0, the one or more bitstream conformation conditions include that a sum of the first syntax element for the last 1-bit position and the second syntax element for the trailing 0-bit is equal to a number of the duplicate vertices in a submesh.

14. The method of claim 8, wherein, when the value of the motion vector derivation disable flag is 0, the one or more bitstream conformation conditions include that a sum of the first syntax element for the last 1-bit position and the second syntax element for the trailing 0-bit is less than or equal to a number of duplicate vertices in a submesh.

15. An apparatus comprising:
a communication interface; and
a processor operably coupled to the communication interface, the processor configured to:
determine a value of a motion vector derivation disable flag and include the value of the motion vector derivation disable flag in signaling information;
determine two syntax elements related to duplicate vertices and include the two syntax elements in the signaling information, wherein the two syntax elements include a first syntax element for a last 1-bit position and a second syntax element for a trailing 0-bit, and wherein one or more bitstream conformance conditions are related to the two syntax elements; and
create a compressed bitstream including the signaling information.

16. The apparatus of claim 15, wherein, when the value of the motion vector derivation disable flag is 1, the one or more bitstream conformation conditions include that the first syntax element for the last 1-bit position and the second syntax element for the trailing 0-bit are both a value of 0.

17. The apparatus of claim 15, wherein the one or more bitstream conformation conditions include that the first syntax element for the last 1-bit position and the second syntax element for the trailing 0-bit are each within a particular range.

18. The apparatus of claim 17, wherein the particular range for the first syntax element for the last 1-bit position is 0 to a first value corresponding to a bash mesh vertex count for a submesh minus 1, inclusive.

19. The apparatus of claim 18, wherein the particular range for the second syntax element for the trailing 0-bit is 0 to a second value corresponding to the bash mesh vertex count for the submesh minus the last 1-bit position minus 1, inclusive.

20. The apparatus of claim 15, wherein, when the value of the motion vector derivation disable flag is 0, the one or more bitstream conformation conditions include that a sum of the first syntax element for the last 1-bit position and the second syntax element for the trailing 0-bit is less than or equal to a number of duplicate vertices in a submesh.
